(19) United States
(12) Patent Application Publication
(10) Pub. No.: US 2016/0363754 A1
(43) Pub. Date: Dec. 15, 2016

(54) A Removable Objective Lens Arrangement

(71) Applicant: European Molecular Biology Laboratory, Heidelberg (DE)

(72) Inventors: Lars Hufnagel, Heidelberg (DE); Uros Krzic, Munich (DE)

(21) Appl. No.: 15/039,131

(22) PCT Filed: Nov. 24, 2014
(86) PCT No.: PCT/EP2014/075437

§ 371 Date: May 25, 2016

(30) Foreign Application Priority Data
Nov. 25, 2013 (GB) 1320728.7

(51) Int. Cl. G02B 21/24; G02B 7/02; G02B 7/14; G02B 21/02

(52) U.S. Cl. CPC G02B 21/24; G02B 21/02; G02B 7/023; G02B 7/14

(57) ABSTRACT

A removable objective lens arrangement (5) having a removable plate (30), at least one support device (60,70) fixably mounted on the removable plate (30) and an objective lens (40) adjustably mounted within the at least one support device (60, 70).

### CROSS-REFERENCE TO RELATED APPLICATIONS

This application claims benefit to and priority of UK Patent Application No. 1320728.7 filed on 25 Nov. 2013.

### FIELD OF THE INVENTION

The field of the invention relates to a removable objective lens arrangement for mounting at least one objective lens.

### BACKGROUND OF THE INVENTION

A microscope is a scientific instrument that is used to image objects, which either are too small themselves or have details that are too small to be visible to the naked eye. There are many types of microscopes available on the market. The most common of these and the first to be invented is the so-called optical microscope, which uses light in a system of lenses to magnify images of the samples. The image from the optical microscope can be either viewed through an eyepiece or, more commonly nowadays, captured by a light-sensitive camera to generate a so-called micrograph. The images were previously captured on photographic film, but modern developments in charge-coupled device (CCD) cameras allow the capture of digital capture and storage of digital images.

The illumination sources used in optical microscopes have been developed over the years and wide varieties of illumination sources are currently available, which can emit light or other types of radiation at different wavelengths. Optical filters can be placed between the illumination source and the sample to be imaged in order to restrict the wavelength of the radiation illuminating the sample.

Modern biological microscopy uses fluorescent probes for imaging specific structures within a cell as the sample. In contrast to normal trans-illuminated light microscopy, the sample in fluorescence microscopy is illuminated through an objective lens with a narrow set of light wavelengths. These narrow set of light wavelengths interact with fluorophores in the sample, which then emit light of a different wavelength. This emitted/fluoresced light is used to construct the image of the sample.

Some modern microscopy methods, for example selective plain illumination microscopes (SPIN), multi-view SPIN and 4 Pi microscopes utilize multiple objective lenses that are focussed on the same experimental volume containing the sample to be imaged. In these microscopy methods, the correct relative position of the multiple objective lenses is important for a proper functioning of the microscope. Experience has shown that the positioning of the multiple objective lenses requires time for adjustment, for example 3 to 4 hours for any new samples. This adjustment has to be repeated if one or more of the multiple objective lenses is removed from the microscope.

For example, suppose that a user wishes to use an objective lens with a different magnification. Each time the objective lenses with different magnifications (or other properties) are exchanged, an adjustment of the relative position has to take place. This adjustment leads to downtime of the microscope.

U.S. Pat. No. 5,668,660 (Hunt) teaches a microscope having an objective lens and a pair of zoom lenses arranged in series along an optical path from the objective lens to a video camera. The objective lens is fixed on a holder, which can be removably mounted in a receptacle on the microscope housing, and is retained therein by a manually releasable latch. The holder includes a number of set screws that co-operate with a spring to permit adjustment of the objective lens and to centre the objective lens after the objective lens has been mounted in the receptacle. The objective lens can be removed from the microscope by depressing a release button and pivoting a latch leaver to its release position, thereby accommodating quick and easy removal of the holder form the receptacle.

The teachings of the Hunt disclosure relate only to a single objective lens within an insert on the microscope. There is no provision for two objective lenses to be mounted at an angle to each other. The set screws and the spring are mounted directly on the microscope in the Hunt disclosure.

German patent application No. DE 10 2006 024 109 (Wahl et. al, assigned to Carl Zeiss Microimaging GmbH, Jena) teaches a microscope with a so-called exchange device. The exchange device has a plurality of optical elements with differing optical properties and which can be quickly exchanged with each other. The microscope has means, which enable the mounting of a single optical element and/or a magazine with optical elements having deferring properties. The arrangement of this disclosure includes a linear slide with a plurality of mounts for accepting optical elements such as filters or reflectors. The optical elements cannot be individual adjusted with the magazine or the linear slide.

### SUMMARY OF THE INVENTION

A removable object lens arrangement comprising a removable plate with at least one support device fixedly mounted to the removable plate is disclosed. An objective lens is adjustably mounted within the at least one support device to enable imaging or/and illumination of a sample. The objective lens is held in position by a front support and a back support of the support device. This lens arrangement allows the placement of the objective lens in a fixed position within a microscope and enables the objective lens to be easily removed from a base plate of the microscope and then reinserted without time-consuming adjustment of the position of the objective lens.

The lens arrangement comprises in one aspect two objective lenses. One of the objective lenses is used to illuminate a sample (an illumination lens) within the microscope and the other one of the objective lenses is used to image the illuminated sample (an imaging lens). The position of each one of the objective lenses can be adjusted in three dimensions, which leads in total to five degrees of freedom. The removable plate holds the objective lenses firmly in position and maintains the relative orientation of the objective lenses to each other to avoid later refocusing and reimaging of the sample.

The front support comprises at least one adjustable screw, formed in one aspect with a bearing and a co-operating spring to move the front end of the objective lens in a front plane. The back end of the support holds the objective lens firmly in position, but allows a movement of the objective lens in the front plane.

A translation device can be used for translating the position of the objective lens in a direction substantially parallel to the plane of the removable plate.

The removable plate comprises fixation devices, which cooperate with a fixed place plate on the microscope, to hold the removable plate in position and to adjust the position of the removable plat on insertion into the microscope.

### DESCRIPTION OF THE FIGURES

FIG. 1 shows two objective lenses mounted on a removable plate.

FIGS. 2a-c shows one of the objective lenses mounted on the removable plate.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

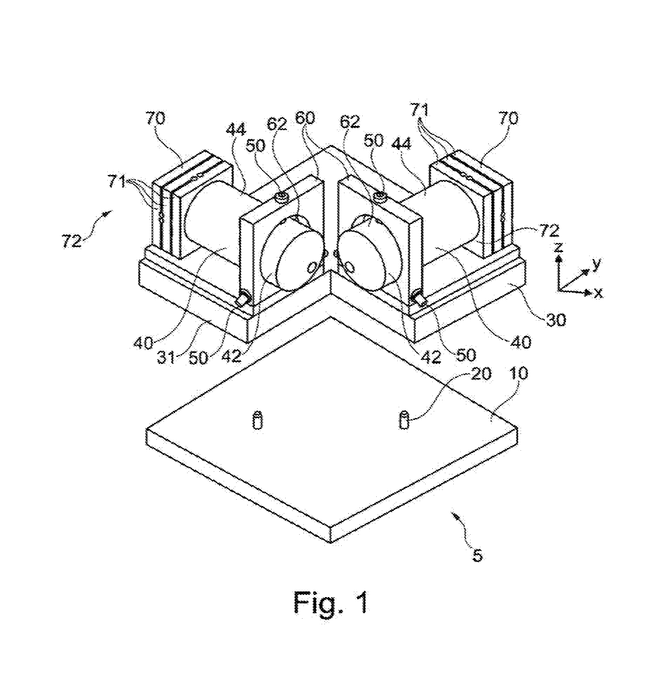

FIG. 1 shows a removable objective lens arrangement 5 with two objective lenses 40 mounted on a removable plate 30 with the help of a support device. The support device comprises a front support 60 for supporting a front end 42 of the objective lens 40. The support device further comprises a hack support 70 for holding the rear end 44 of the objective lens 40.

The removable plate 30 can be mounted on a fixed base plate 10, which is part of a microscope. The fixed base plate 10 has, in this example, one or more pins 20, which cooperate with recesses (not shown) on the underside 31 in the removable plate 30 to fix the removable plate 30 on the base plate 10. It will be appreciated that other forms of fixation devices can be used in order to fixedly hold the removable plate 30 on the base plate 10.

The front support 60 has a front opening 62 through which the front end 42 of the objective lens 40 is inserted. The front end 42 of the objective lens 40 is held in position in the front support 60 by means of adjustable screws 50. FIG. 1 shows three adjustable screws 50 mounted at approximately 120 degrees to each other, but this is not limiting the invention. It will be appreciated that fewer or more adjustable screws 50 can be used. The adjustable screws 50 are used to move the objective lens 40 in two dimensions in a plane of the front support 62 located perpendicularly to the axis of the objective lens 40, shown as directions y and z for the left hand objective lens 40 in FIG. 1. It will be noted that one or more of the adjustable screws 50 can be replaced by a spring and bearing or similar to support the objective lens 40.

It will be appreciated that an operator can therefore adjust both of the two objective lenses 40 shown in FIG. 1 such that a sample (not shown) is illuminated by one of the objective lenses 40 and imaged by another one of the objective lenses 40. The two objective lenses 40 are mounted so that their optical axes are at substantially right angles to each other.

The back support 70 is formed of a so-called flexure which comprises, in this aspect, three aluminium bands 71 which can be tightened about the objective lens 40, but allow movement in the plane of the front support 62.

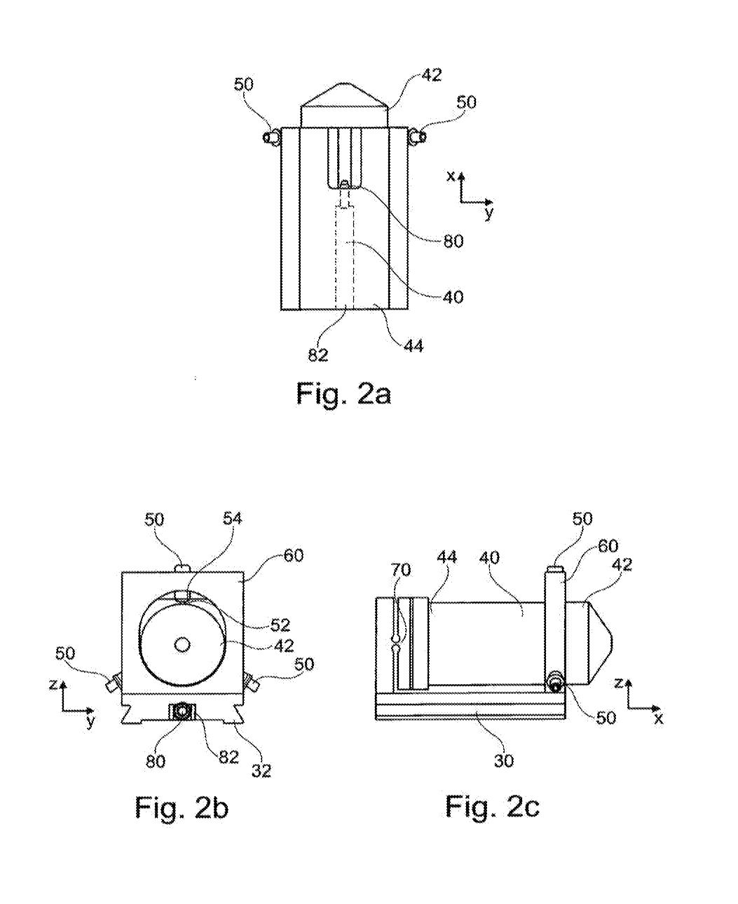

FIG. 2 shows the objective lens 40 in three views. FIG. 2a is a cross-sectional view. FIG. 2b is a front view from the front end 42 of the objective lens 40 and FIG. 2c is a side view of the objective lens 40. The same reference numerals are used in FIGS. 2a-c as in FIG. 1 and represent the same elements.

FIG. 2a shows additionally a translation screw 80, which is used to adjust the longitudinal direction (x-direction) of the objective lens 40 within the support device. It will be seen, from FIG. 2b, that the adjustable screw 80 is inserted into a corresponding hole 82 in the removable plate 30.

The adjustable screws 50 have a bearing 52 cooperating with a spring 54 to hold the front end 52 of the objective lens 40 within the front support 60.

It will be seen from FIG. 2 that the removable plate 30 has a dove tail 32 which cooperate with corresponding fixations on the base plate 10 to hold the removable plate 30 into position.

1. A removable objective lens arrangement comprising:
a removable plate;
at least one support device fixably mounted on the removable plate; and
an objective lens adjustably mounted within the at least one support device.

2. The lens arrangement of claim 1, wherein the at least one support device comprises:
a front support for supporting a front end of the objective lens; and
a back support for holding a rear end of the objective lens.

3. The lens arrangement of claim 2, wherein the front support comprises at least one adjustable screw for adjusting a position of the objective lens within the support device.

4. The lens arrangement of claim 2, wherein the front support comprises at least one spring arrangement for holding the objective lens within the support device.

5. The lens arrangement of claim 2, wherein the back support comprises a flexure.

6. The lens arrangement of claim 1, further comprising a translation screw within the removable plate for translating the objective lens in a direction substantially parallel to the surface of the removable plate.

7. The lens arrangement of claim 1, wherein the removable plate has fixation devices co-operating with a base plate for affixing the arrangement on the base plate.

8. The lens arrangement of claim 1, further including a further objective lens adjustably mounted within a further support device.

9. The lens arrangement of claim 8, wherein the further objective lens is arranged such that an optical axis of the further objective lens is substantially at right angles to the optical objective lens.

10. A microscope comprising a base plate with fixation devices for affixing the lens arrangement of claim 1.
